(19) United States
(12) Patent Application Publication
(10) Pub. No.: US 2006/0061951 A1
(43) Pub. Date: Mar. 23, 2006

(54) Method for controlling computer system having wireless display and computer system

(75) Inventor: Takuya Hara, Kasai (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/273,398

(22) Filed: Nov. 15, 2005

Related U.S. Application Data
(63) Continuation of application No. PCT/JP03/06788, filed on May 29, 2003.

(51) Int. Cl. G06F 1/16

(52) U.S. Cl. 361/683

(57) ABSTRACT

A system includes a computer main unit (3) for performing data processing, a cradle (5) for a display device that is connected to the computer main unit so that signals or data can be communicated between them, a wireless display (6) that is detachably connected to the cradle and is capable of communicating signals or data with the cradle or the computer main unit via wireless communication, a connector, a resistor or the like as a detecting portion for detecting a connected or detached state of the wireless display with respect to the cradle, and a NOR circuit (35) or a power control portion (33, 33B) as a control portion for inhibiting power control by an operation in the computer main unit when the wireless display is detached from the cradle and the computer main unit is working.

### TECHNICAL FIELD

The present invention relates to a method for controlling a computer system having a wireless display and a computer system. In particular, the present invention is used for controlling power supply to a computer system in which a wireless display can be switched between a wired operation and a wireless operation.

### BACKGROUND ART

Presently, there is provided a computer system that allows its display to be separated and carried for use to any place such as a living room or a kitchen in a house. In this computer system, a computer main unit and a display are connected to each other via a wireless network.

The display (wireless display) employs a flat display panel such as a liquid crystal display device that works on a secondary battery as its power source, and it is adapted to be compact and lightweight so as to be capable of being carried independently. The display has a function of processing as a computer as well as a function of wireless communication, and it includes a touch panel for entering data and instructions. The computer main unit is disposed on any place such as a shelf or a desk, so that the computer main unit is controlled remotely by the display. A user can hold the display by his or her hand for enjoying Web surfing, searching various kinds of information, checking electronic mails, or enjoy other various applications.

In addition, there is proposed a wireless network system in which a stand is prepared for supporting the display in a standing posture and the display (wireless display) is adapted to be connected to the stand detachably (see the Patent Document 1 below). In the proposed system, the stand is connected to a power line so that power is supplied to the display from the power source line when the display is attached to the stand, while a secondary battery equipped to the display is charged. When the display is detached from the stand, the display works on the secondary battery as a power source. The display does wireless communication with a computer main unit (a broadcast program recording device) that is disposed separately so that a program desired by a user is received and its images can be displayed.

In this way, the computer system including a wireless display enables a user to carry the display freely and separately from the fixed computer main unit, so that the user can use all or most functions of the computer system at any place in a house or an office.

However, if the user carries the display to another room separately from the computer main unit and uses the display for a while, it is not necessary to operate the computer main unit directly, and it is not necessary to approach the vicinity of the computer main unit. Under such circumstances, another person may misunderstand that the computer main unit is not used although its power is turned on, and he or she may turn off the power of the computer main unit. In this case, an application in service may be interrupted forcedly so that the computer system may be terminated in an abnormal state. Then, the user who was using the computer has to do a cumbersome task to recover the original state, or some data can be lost in some cases.

Patent Document 1: Japanese Unexamined Patent Publication No. 2002-204408

### DISCLOSURE OF THE INVENTION

An object of the present invention is to prevent a computer system including a wireless display from being turned off power due to a delusion that the computer system is not used despite the fact that it is under use.

According to one aspect of the present invention, there is provided a method for controlling a computer system including a wireless display that is detachably connected to a cradle and a computer main unit. The method includes controlling the computer system so that power control by an operation in the computer main unit is not performed when the wireless display is detached from the cradle and the computer main unit is working.

According to another aspect of the present invention, there is provided a computer system that includes a computer main unit for performing data processing, a cradle for a display device that is connected to the computer main unit so that signals or data can be communicated between them, a wireless display that is detachably connected to the cradle and is capable of communicating signals or data with the cradle or the computer main unit via wireless communication, a detecting portion for detecting a connected or detached state of the wireless display with respect to the cradle, and a control portion for inhibiting power control by an operation in the computer main unit when the wireless display is detached from the cradle and the computer main unit is working.

### BRIEF DESCRIPTION OF THE DRAWINGS

FIG. 1 is a diagram showing a general structure of a computer system according to a first embodiment of the present invention, FIG. 2A is a perspective view showing an example of an external view of a cradle, FIG. 2B is a perspective view showing an example of an external view of a display, FIG. 3 is a block diagram showing a circuit structure of the computer system, FIG. 4 is a diagram showing a control state in accordance with an operation of a power switch corresponding to a connected or detached state of the display, FIG. 5 is a flowchart showing control contents in the computer system, and FIG. 6 is a block diagram showing a circuit structure of a computer system according to a second embodiment of the present invention.

### BEST MODE FOR CARRYING OUT THE INVENTION

### FIRST EMBODIMENT

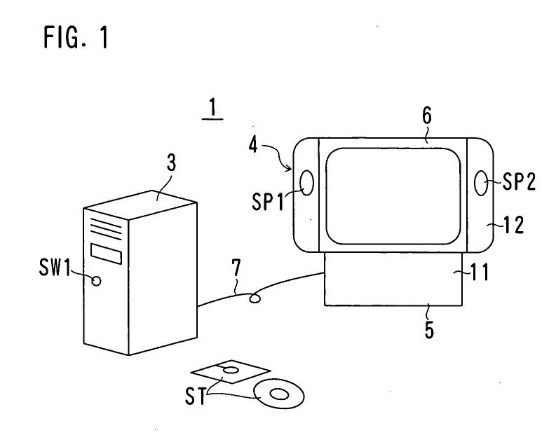

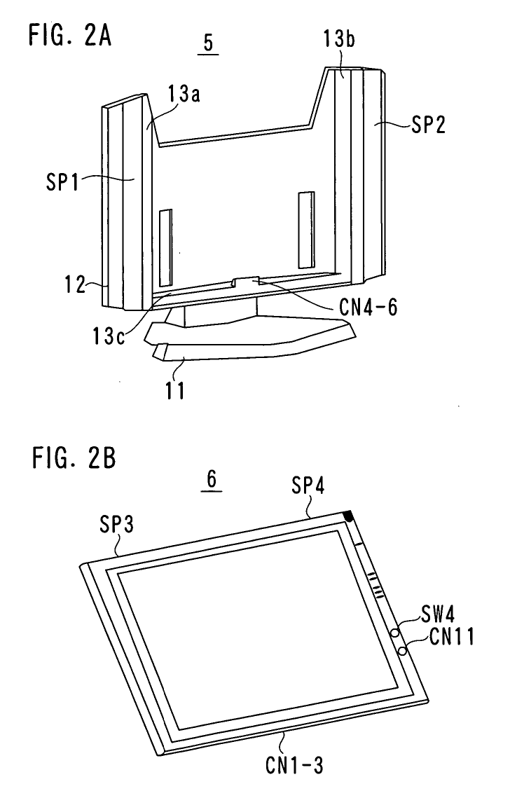

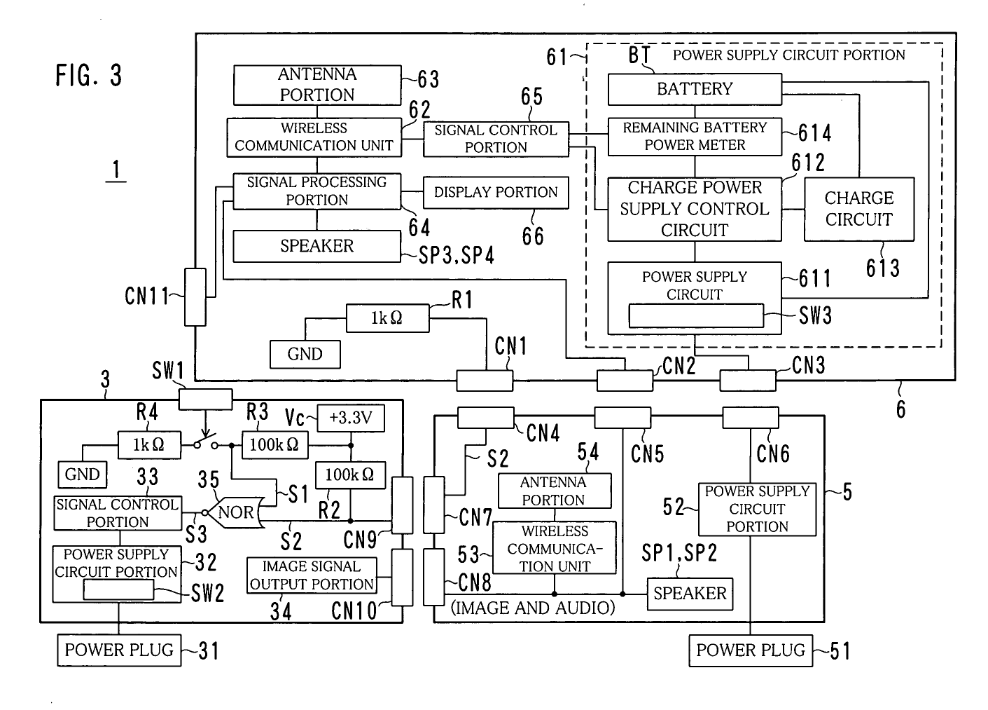

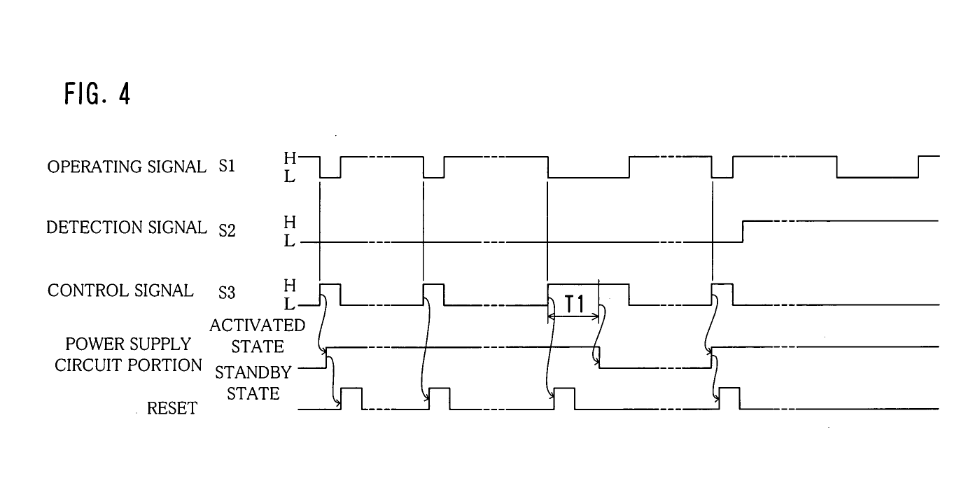

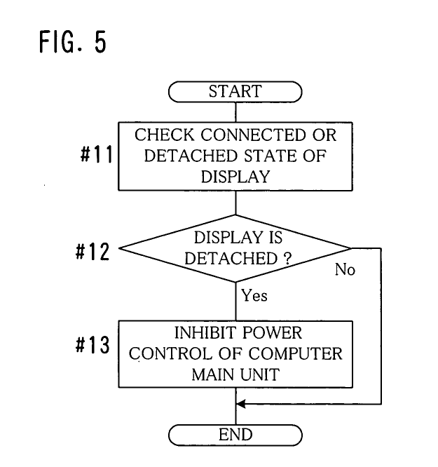

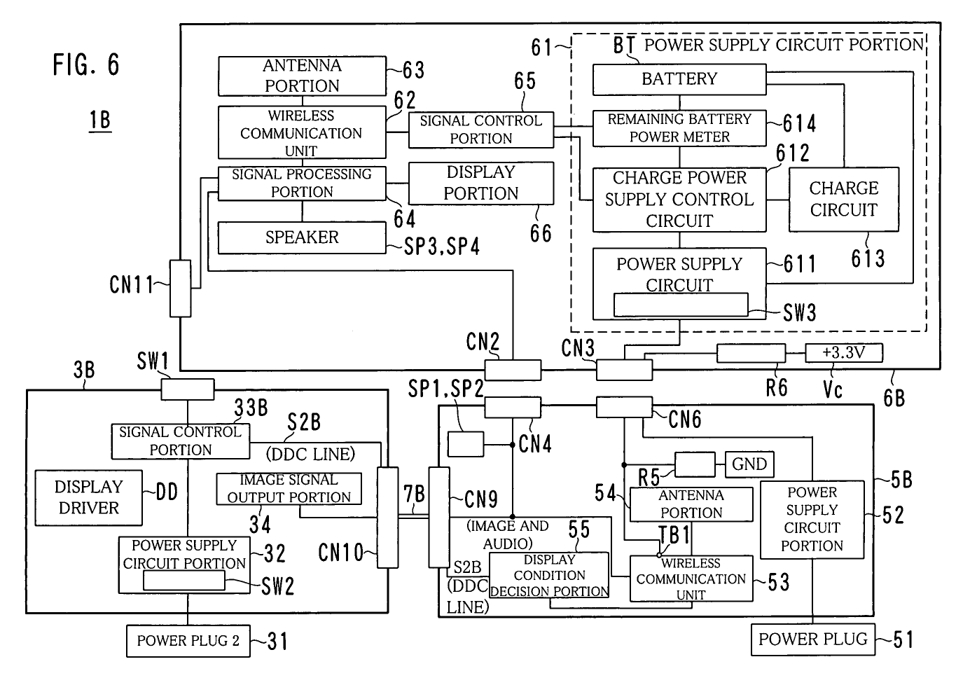

As shown in FIG. 1, a computer system 1 includes a computer main unit 3, a display device 4 and a cable 7 for connecting them to each other.

The computer main unit 3 includes a CPU, a RAM, a ROM, other peripheral elements, various interfaces, a hard disk drive and a magneto-optical disk drive. Various application programs are executed on an operating system (OS) so that various kinds of data processing are performed. Data are read or written on various recording media ST such as a CD-ROM or a flexible disk. A power plug is connected to a power source line to be supplied with AC power. A power switch SW1 is provided, and power is turned on or off or reset by operating the power switch SW1. However, the computer system 1 of this embodiment can ignore the operation of the power switch SW1 depending on a connected or detached state of the display device 4. Detail will be described later. In addition, a printer, a mouse, a keyboard and a communication line to a network are connected or can be connected to the computer main unit 3 although they are not shown.

The display device 4 includes a cradle 5 and a display 6 that can be detachably connected to the cradle 5.

As shown in FIG. 2 well, the cradle 5 is a stand for supporting the display 6 in a standing posture, and it includes a base portion 11 and a holding portion 12 that can be tilted with respect to the base portion 11. The holding portion 12 is provided with holding faces 13a and 13b at both sides to which the display 6 is attached and engaged, and it is provided with a holding face 13c at the lower portion. The upper face of the holding face 13c is provided with connectors CN4-CN6 for communicating signals when the display 6 is attached. When the display 6 is attached, the connectors CN4-CN6 are connected with connectors CN1-CN3 of the display 6. The holding portion 12 is provided with connectors CN7 and CN8 on the back face to which the cable 7 is connected. The holding portion 12 is provided with speakers SP1 and SP2 at both sides of the front face.

The display 6 employs a liquid crystal display device or the like with a touch panel, and it has a rectangular shape as viewed from the front. It is provided with connectors CN1-CN3 on the bottom face, small speakers SP3 and SP4 at both ends of the upper face, and a switch SW4 and a USB connector CN11 at the edge portion of the front face. The switch SW4 is used for turning on and off or resetting power supply to the computer main unit 3 by remote control. The USB connector CN11 is used for connecting a mouse or the like.

The display 6 obtains image signals and power through the connectors CN1-CN3 when it is attached to the cradle 5, while it works on an internal battery as a power source when it is detached from the cradle 5 so as to receive image signals from the cradle 5 and communicate various signals and data with the same by wireless communication using radio wave, infrared radiation or the like. In this way, the display 6 is a wireless display that can communicate signals and data with the cradle 5 by wireless communication.

The cable 7 includes a first cable for connecting the connector CN7 with the connector CN8 and a second cable for connecting the connector CN9 with the connector CN10. In this case, the first cable is a special purpose cable for sending a detection signal S2. However, it is possible to integrate the first cable and the second cable into one cable.

Next, a circuit structure and a function of each portion will be described in detail. However, description and illustration of a known circuit and its function of each portion will be omitted or simplified, and a structure that is characterized by this embodiment will be described mainly.

As shown in FIG. 3, the computer main unit 3 is provided with a power plug 31, a power supply circuit portion 32, a signal control portion 33, an image signal output portion 34, a NOR circuit 35, resistors R2, R3 and R4, connectors CN9-CN10 and the power switch SW1 described above.

When the power plug 31 is connected to a power source line, the power supply circuit portion 32 becomes a standby state if the power switch SW2 is turned on. The power supply circuit portion 32 maintains the standby state or becomes activated state responding to a signal from the signal control portion 33. In the standby state, only minimum power that is necessary for monitoring each portion of the computer system 1 and booting up is supplied. In the activated state, power that is necessary for normal operation of the computer system 1 is supplied.

The signal control portion 33 produces a signal that is necessary for controlling the power supply circuit portion 32 and a signal that is necessary for resetting the CPU by hardware or software in accordance with an output signal (control signal) S3 of the NOR circuit 35.

The image signal output portion 34 produces an image signal to be displayed on the display 6, an audio signal to be reproduced by the speakers SP, synchronizing signals and other necessary signals.

The power switch SW1 can be operated for a user to press with a finger, and it is turned on by pressing and off by releasing. When the power switch SW1 is turned on, one of the input terminals of the NOR circuit 35 is connected to the ground via the resistor R4. Therefore, when the power switch SW1 is turned off, an input signal (operating signal) S1 of the NOR circuit 35 that is connected to a control voltage Vc via the resistor R3 is in the “H” state. The input signal S1 is in the “L” state while the power switch SW1 is turned on.

The other input terminal of the NOR circuit 35 is connected to the control voltage Vc via the resistor R2, and it becomes the “L” or “H” state depending on the connected or detached state of the display 6. In other words, when the display 6 is attached to the cradle 5, the input terminal is connected to the ground via the connector CN9, the connector CN7, the connector CN4, the connector CN1 and the resistor R1, and the input signal (detection signal) S2 becomes the “L” state. When the display 6 is detached from the cradle 5, the connector CN4 is disconnected from the connector CN1. Therefore, it is not connected to the ground via the resistor R1 so that the detection signal S2 becomes the “H” state. In this way, the connected or detached state of the display 6 can be detected in accordance whether the resistor R1 is connected to the ground or not, and the detection signal S2 is given to the NOR circuit 35. In other words, it is determined whether the display 6 is attached or detached in accordance whether the detection signal S2 is the “L” or the “H” state. The detection signal S2 is also used for controlling the wireless communication unit 53 that will be described later, and it can be used for other control.

Note that although the resistors R1 and R4 have resistance of 1 K ohm and the resistors R2 and R3 have resistance of 100 K ohm, these resistance values and a value of the control voltage Vc can be modified variously.

The NOR circuit 35 produces the output signal S3 of the “H” level when both the input signals S1 and S2 are the “L” level, while it produces the output signal S3 of the “L” level when at least one of the input signals S1 and S2 is the “H” level.

Therefore, when the display 6 is attached to the cradle 5 and so the connectors CN1-CN3 are connected with the connectors CN4-CN6 resulting in the “L” level of the detection signal S2, the output signal S3 is switched between the “H” and the “L” levels in accordance with an operation of the power switch SW1. In other words, an operation of the power switch SW1 is valid in this case. More specifically, if the power switch SW1 is turned on, the signal S1 becomes the “L” level so that the output signal S3 becomes the “H” level. If the power switch SW1 is turned off, the signal S1 becomes the “H” level so that the output signal S3 becomes the “L” level.

In contrast, if the display 6 is detached from the cradle 5 and so the connectors CN1-CN3 are disconnected from the connectors CN4-CN6 resulting in the “H” level of the detection signal S2, the output signal S3 becomes the “L” level regardless of a state of the signal S1, i.e., a state of turned on or off of the power switch SW1. In other words, an operation of the power switch SW1 is neglected in this case. Therefore, even if the power switch SW1 is operated, the output signal S3 maintains the “L” level so that the activated state of the power supply circuit portion 32 cannot be changed nor reset. In other words, the operating signal S1 generated by the operation of the power switch SW1 is interlocked by the detection signal S2. In other words, it is controlled so that a power control by the operation of the power switch SW1 is inhibited when the display 6 is detached and the computer main unit 3 is working. In this way, the NOR circuit 35 can be an interlock circuit.

As shown in FIG. 4, for example, if the detection signal S2 is the “L” state and the operating signal S1 is entered by the operation of the power switch SW1, the control signal S3 is produced responding to the same and the power supply circuit portion 32 is changed to the activated state. In this state, if the power switch SW1 is turned on for a time period longer than the time T1, the power supply circuit portion 32 is changed to the standby state. However, if the detection signal S2 is the “H” state, the control signal S3 is not produced even if the power switch SW1 is operated. Therefore, the power supply circuit portion 32 that is in the activated state is not changed to the standby state or reset.

Note that the contents of the power control shown in FIG. 4 is merely an example, and the contents of the power control or a control sequence can be modified variously, including how the power switch SW1 is operated or how the power supply circuit portion 32 is controlled or how the reset process is performed.

In addition, although the power switch SW1 is also used as the switch for reset process, the switches may be provided independently. In this case, each of the power switch and the reset switch is interlocked by the detection signal S2 as described above.

The cradle 5 is provided with a power plug 51, a power supply circuit portion 52, a wireless communication unit 53, an antenna portion 54, the connectors CN4-CN8 described above and the like.

When the power plug 51 is connected to the power source line, the power supply circuit portion 52 becomes the activated state. The power supply circuit portion 52 supplies power to the display 6 via the connector CN6. Note that it is possible to design to supply power from the power supply circuit portion 32 of the computer main unit 3 without using the power plug 51.

The wireless communication unit 53 and the antenna portion 54 perform wireless communication of various data with a wireless communication unit 62 and an antenna portion 63 that are provided to the display 6. In the first embodiment, the communication can be performed only between them in a one-to-one manner. However, it is possible that a code for selecting the other party of the communication can be set and the setting can be changed so that other display device or a general wireless LAN can be the other party of the communication. If the wireless LAN is used, for example, IEEE standards 802.11a, 802.11b, 802.11g and the like can be used. Note that the wireless communication units 53 and 62 are adapted to work only when the display 6 is detached from the cradle 5, so it stops working when the display 6 is attached. However, it is possible to design so that the wireless communication units 53 and 62 work regardless of the connected or detached state of the display 6.

The display 6 is provided with a power supply circuit portion 61, the wireless communication unit 62, the antenna portion 63, a signal processing portion 64, a signal control portion 65, a display portion 66 and the connectors CN1-CN3 and CN11, the speakers SP3 and SP4 and the resistor R1 described above.

The power supply circuit portion 61 includes a power supply circuit 611, a charge power supply control circuit 612, a charge circuit 613, a remaining battery power meter 614 and a battery (secondary battery) BT.

The power supply circuit 611 works by power supplied from the power supply circuit portion 52 of the cradle 5 when the power switch SW3 is turned on, and it supplies necessary power to each portion. The charge power supply control circuit 612 controls the charge circuit 613 and the remaining battery power meter 614 in accordance with control by the signal control portion 65. The charge circuit 613 charges the battery BT. The remaining battery power meter 614 detects remaining power of the battery BT and displays the same.

Note that if the display 6 is not supplied with power from the cradle 5 when it is detached from the same, the voltage that is supplied to the power supply circuit 611 becomes zero or decreases. This state is detected, and the power supply is changed automatically to that from the battery BT.

The wireless communication unit 62 and the antenna portion 63 perform the wireless communication with the wireless communication unit 53 and the antenna portion 54 of the cradle 5 as described above, so as to receive the image signal, the audio signal and other signal and data from the cradle 5, or exchange various data.

The signal processing portion 64 performs a process of various signals and data, and it performs various interface functions. The signal control portion 65 controls each portion of the display 6. The display portion 66 is a liquid crystal display device having a touch panel. It displays images corresponding to image signals delivered from the signal processing portion 64. Concerning the display on the display portion 66, it is possible to display with reduced resolution for decreasing data quantity of the wireless communication when the display 6 is detached. The input signal from the touch panel of the display portion 66 is given to the signal processing portion 64, in which a predetermined process is performed on the signal and the signal is transmitted to the cradle 5 via the wireless communication unit 62.

The resistor R1 is provided for the purpose of detecting the connected or detached state of the display 6 as described above, and the detection signal S2 is connected to the ground to be the “L” state when the connector CN1 is connected with the connector CN4.

Note that the display 6 includes a CPU, a ROM and a RAM so as to have a function as a computer.

According to the computer system 1 described above, when the display 6 is detached from the cradle 5, it is detected automatically so that an operation of the power switch SW1 is neglected. Therefore, while the display 6 is carried to another room and used in the room separated from the computer main unit 3, it is prevented that the power is turned off due to delusion that the computer main unit 3 is not used despite the truth that it is used actually.

When the display 6 is attached to the cradle 5, it is detected automatically so that an operation of the power switch SW1 becomes valid. Therefore, its power can be turned off and on or reset by normal operations.

Note that if the user wants to turn off the power of the computer main unit 3 when the display 6 is detached from the cradle 5, the user can end application programs by normal operations and shut off by ending the OS. In addition, the switch SW4 is operated for turning off or resetting the computer main unit 3 forcibly. In order to turn on the power of the computer main unit 3 by an operation on the display 6, the switch SW4 is operated. In these cases, a signal corresponding to the operation of the switch SW4 is transmitted to the cradle 5 via the wireless communication unit 62, and the signal is sent to the computer main unit 3. In the computer main unit 3, the signal control portion 33 or the power supply circuit portion 32 is controlled in accordance with the signal.

Therefore, it is so set that the wireless communication unit 62 is the activated state also when the power of the computer main unit 3 is turned off or that the wireless communication unit 62 becomes the activated state when the switch SW4 is operated.

In addition, the display 6 is attached to the cradle 5 for operating the power switch SW1 in the case where the switch SW4 is not used or not provided.

Although the NOR circuit 35 is used for obtaining the control signal S3 in the first embodiment described above, it is possible to use a NAND circuit, an AND circuit, an OR circuit or a combination thereof or other various interlock circuit. In the display 6, it is possible to detect the connected or detached state of the display 6 by detecting a voltage across both ends of the resistor R1. It is possible to provide the resistor R1 not to the display 6 but to the cradle 5, connect an end of the resistor R1 to the connector CN4 and connect a jumper to the connector CN1, so that the terminal of the resistor R1 in the connector CN4 and the terminal for the detection signal S2 are connected by the jumper of the connector CN1. It is also possible to provide one or both of the cradle 5 and the display 6 with a sensor for detecting presence of the other party, so that an output signal of the sensor is used as the detection signal S2.

Furthermore, various circuits or mechanisms can be used for detecting the connected or detached state of the display 6.

### SECOND EMBODIMENT

Next, a computer system 1B of a second embodiment will be described.

The computer system 1B of the second embodiment is different from the computer system 1 of the first embodiment in the method of detecting the connected or detached state of the display 6 and the method of transmitting the detection signal S2 to the computer main unit 3, while other structures are the same between them. Therefore, the same reference signs are used for parts having the same functions as the computer system 1 of the first embodiment so as to omit or simplify descriptions.

In the second embodiment, a display driver that is software for controlling the display device 4 enables to detect the connected or detached state of the display 6. In other words, the display driver for controlling the display device 4 should be installed in the computer main unit 3, and a program for detecting the connected or detached state of the display 6 is incorporated in the display driver. Such a program checks, for example, whether or not the wireless communication unit 53 is working. Alternatively, it checks a connection state between the connectors CN2, CN3 and the connectors CN5, CN6. It is sufficient to perform such a check once every several seconds, for example. Instruction data for checking and data indicating a check result can be transmitted by using a line for communicating signals or data with the display device 4 and by encoding, or by using a time-sharing method.

The general information of the process by the program will be described with reference to flowcharts.

As shown in FIG. 5, the connected or detached state of the display 6B is checked (#11). If the display 6B is detached (Yes in #12) and the computer main unit 3B is working, power control of the computer main unit 3B by operation of the power switch SW1 or the like is inhibited (#13).

Such a program can be provided by a recording medium ST such as a CD-ROM or a flexible disk. In addition, it can be downloaded from a server via a communication line.

A D-SUB cable for transmitting analog signals is used as the cable 7B. The cable 7B includes a signal line called a display data channel (DDC) line. The DDC line is used for communicating plug and play display information. Therefore, its function can be used for checking the connected or detached state of the display 6 and obtaining data of the check result.

As shown in FIG. 6, the computer system 1B includes a computer main unit 3B, a display device 4B and a cable 7B for connecting them to each other. The display device 4B includes a cradle 5B and a display 6B.

A display driver DD is installed in the computer main unit 3B. The display driver DD checks the connected or detached state of the display 6B at an interval of 5-10 seconds as described above, and a detection signal S2B obtained by the check is sent to a power control portion 33B. The power control portion 33B controls the power supply circuit portion 32 responding to an operation of the power switch SW1, but the above-mentioned interlock is made by the detection signal S2B.

The cradle 5B is provided with a display condition decision portion 55. The display condition decision portion 55 checks whether or not the wireless communication unit 53 is working, and a detection signal S2B as the check result is sent out to the DDC line.

The wireless communication unit 53 is provided with a control terminal TB1 for controlling an operation thereof. The control terminal TB1 is connected to the connector CN6, and it is connected to the ground via a resistor R5. In addition, the display 6B includes a connector CN3, which is connected to the control voltage Vc via a resistor R6.

When the display 6B is attached, the control voltage Vc is applied to the control terminal TB1 via the connector CN6, the connector CN3 and the resistor R6. Thus, the connected state of the display 6B is detected so that the wireless communication unit 53 stops working. When the display 6B is detached, the connector CN3 is disconnected from the connector CN6. Therefore, the control voltage Vc is not applied so that the wireless communication unit 53 becomes the activated state. Note that the control terminal TB1 is supplied with a voltage that is generated by dividing the control voltage Vc by the resistor R6 and the resistor R5. Therefore, in the display 6B too a voltage of the terminal of the resistor R6 at the side that is connected to the connector CN3 is monitored for detecting the connected or detached state of the display 6B. Although a value of the resistors R6 and R5 is 50 K ohm, for example, these resistance values and the ratio of the resistance values can be selected appropriately.

Although the detection signal S2B is generated by checking whether or not the wireless communication unit 53 is working in the above-mentioned second embodiment, it is possible to check directly the connection state between the connector CN3 and the connector CN6. Furthermore, it is possible to use various circuits or mechanisms for checking or detecting the connected or detached state of the display 6.

In the second embodiment too, when the display 6B is detached from the cradle 5B, it is detected or checked automatically so that an operation of the power switch SW1 is neglected in the same way as the case of the first embodiment. Therefore, it is prevented that the power is turned off unexpectedly due to delusion that the computer main unit 3B is not used despite the fact that it is used actually.

In addition, since the connected or detached state of the display 6 is checked by the display driver DD and the detection signal S2B is obtained by the DDC line, a standard cable can be used as the cable 7B for connecting the computer main unit 3 with the display device 4.

In the embodiments described above, an operation of the power switch SW1 is neglected when the display 6 or 6B is detached and the computer main unit 3 or 3B is working. In other words, when the computer main unit 3 or 3B is performing a normal process, the process is not interrupted by an operation of the power switch SW1. However, it is possible to neglect an operation of the power switch SW1 when the computer main unit 3 or 3B is not working, e.g., when entering a power saving mode or a standby mode. In addition, it is possible to inhibit the power control only in the direction toward stopping the computer main unit 3 when the power switch SW1 is operated and not to inhibit the power control in the direction toward activating the computer main unit 3, e.g., a control of returning from the power saving mode or the standby mode to the normal mode, or a control of turning on the power.

A storage device such as a main memory, a RAM, a ROM or a hard disk of the computer main unit 3 or 3B, a mobile medium such as a CD-ROM, a flexible disk or a magneto-optical disk, or a network medium such as a server or a DASD that is connected to a network or a communication line can be used as the recording medium ST of the program for performing the method of the present invention.

If the recording medium ST is a mobile medium, the program is read out by a drive device corresponding to a type of the mobile medium. The program is stored in the storage device of the computer main unit or is loaded to the main memory to be executed. If the recording medium ST is a network medium, the program is downloaded to the storage device via the communication line or transmitted to the same to be executed. The program can be supplied so that it works on various operating systems and platforms, or under system environments or network environments.

In the embodiments described above, the structure of each part or the whole of the computer systems 1 and 1B, the circuit, the element to be used, the constant, the number or the layout of the elements, the voltage values or the like can be changed if necessary in accordance with the spirit of the present invention. The computer system of the present invention includes various devices having a CPU or a microprocessor, for example, a video reproducing device, a television set, other video output device, and various devices for home use or business use. In these devices, the computer main unit can be a part that is separated from the display device 4 and is equipped with a CPU to have a data processing function.

### INDUSTRIAL APPLICABILITY

As described above, according to the present invention, when the display is detached from a cradle, it is detected or checked automatically so that an operation of the power switch or the reset switch becomes neglected. Therefore, it is prevented that the power is turned off unexpectedly due to delusion that the computer main unit is not used despite the fact that it is used actually. The present invention is useful for a computer system including a wireless display.

1. A method for controlling a computer system including a wireless display that is detachably connected to a cradle and a computer main unit, the method comprising the step of:
controlling the computer system so that power control by an operation in the computer main unit is not performed when the wireless display is detached from the cradle and the computer main unit is working.

2. A power control device for a computer system including a wireless display that is detachably connected to a cradle and a computer main unit, the device comprising:
a detecting portion for detecting a connected or detached state of the wireless display with respect to the cradle; and
a control portion for inhibiting power control by an operation in the computer main unit when the wireless display is detached from the cradle and the computer main unit is working.

3. A computer system comprising:
a computer main unit for performing data processing;
a cradle for a display device that is connected to the computer main unit so that signals or data can be communicated between them;
a wireless display that is detachably connected to the cradle and is capable of communicating signals or data with the cradle or the computer main unit via wireless communication;
a detecting portion for detecting a connected or detached state of the wireless display with respect to the cradle; and
a control portion for inhibiting power control by an operation in the computer main unit when the wireless display is detached from the cradle and the computer main unit is working.

4. The computer system according to claim 3, wherein the detecting portion detects that the wireless display is detached when a connector of the cradle is disconnected from a connector of the wireless display.

5. The computer system according to claim 3 or 4, wherein a detection signal by the detecting portion is supplied to the computer main unit via a signal line for special purpose between the computer main unit and the cradle.

6. The computer system according to claim 3 or 4, wherein the detecting portion detects the connected or detached state when a program is executed, the program included in a display driver that is installed in the computer main unit, and
a detection signal by the detecting portion is supplied to the computer main unit via a signal line for display between the computer main unit and the cradle.

7. The computer system according to claim 3 or 4, wherein the control portion includes an interlock circuit that makes an interlock so as to invalidate an operation in the computer main unit by a signal of detection indicating that the detecting portion has detected detachment of the wireless display.

8. A computer program for power control of a computer system including a wireless display that is detachably connected to a cradle and a computer main unit, the computer program makes the computer main unit execute the process comprising the steps of:
detecting a connected or detached state of the wireless display with respect to the cradle; and
inhibiting power control by an operation in the computer main unit when the wireless display is detected to be detached from the cradle and the computer main unit is working.

9. A recording medium that is readable by a computer, in which said program is stored.
